(19) United States
(12) Patent Application Publication
(10) Pub. No.: US 2024/0120982 A1
(43) Pub. Date: Apr. 11, 2024

(54) METHOD AND APPARATUS FOR ADAPTIVE ANTENNA CONFIGURATION IN A USER EQUIPMENT

(71) Applicant: SAMSUNG ELECTRONICS CO., LTD., Suwon-si (KR)

(72) Inventors: Kailash Kumar JHA, Bangalore (IN); Subbarayudu Mutya, Bangalore (IN); Anoop Perumudi Veedu, Bangalore (IN); Nishant, Bangalore (IN); Ashok Kumar Reddy Chavva, Bangalore (IN); Jagadeesh Gurugubelli, Bangalore (IN)

(21) Appl. No.: 18/101,792

(22) Filed: Jan. 26, 2023

(30) Foreign Application Priority Data
Oct. 10, 2022 (IN) 202241057977

(51) Int. Cl. H04B 7/06; G01S 5/02; H04B 7/0404; H04W 24/08; H04W 52/02; H04W 68/00

(52) U.S. Cl. CPC H04B 7/0693; G01S 5/0295; H04B 7/0404; H04W 24/08; H04W 52/0245; H04W 68/005

(57) ABSTRACT

The disclosure relates to a method and system for adaptive antenna configuration in a user equipment comprising one or more antenna modules, each of the one or more antenna modules comprising a plurality of patch elements. The method comprises: determining whether a signal strength of the UE is above a signal threshold, determining whether a mobility of the UE is below a mobility threshold based on determining that the signal strength is above the signal threshold, determining at least one active antenna module based on determining that the mobility of the UE is below the mobility threshold, and deactivating at least one patch element in the at least one antenna module.

### CROSS REFERENCE TO RELATED APPLICATIONS

This application is based on and claims priority under 35 U.S.C. § 119 to Indian Patent Application Serial No. 202241057977 (CS), filed on Oct. 10, 2022, in the Indian Patent Office, the disclosure of which is incorporated by reference herein in its entirety.

### BACKGROUND

### Field

The disclosure relates method and system for adaptive antenna configuration in a user equipment.

### Description of Related Art

In 5G systems, there are two types of frequency ranges supported, e.g., frequency range-1 (FR1, less than 6 GHz) and frequency range−2 (1R2 (mmWave), above 24 GHz). For mmWave, separate mmWave modules (e.g., radio frequency (RF) modules) are used 20 in user equipment (UE). Each module operates with 2 or 3 or 4 FR2 bands (e.g., n258, n260 etc.) Basically, each mmWave module can support all or some of the FR2 bands. Each mmWave module can steer beam of the antenna in specific direction based on the theta, phi of the specific carrier.

In a mmWave supported UE, typically there are multiple (2 or 3 or 4) mmWave modules based on the configurations. The mmWave modules contain integrated circuits related to power management, intermediate frequency block and antenna array, such as radio frequency integrated circuit (RFIC), power management integrated circuits (PMIC) and antenna array. At any point of time, only one of the mmWave modules is used for beam management. Multiple modules can be active but will consume high power. Each mmWave module contains 4 set of 1×4 phased/dipole array of antennas or 4 set of 1×5 phased/dipole antenna. When a module is active or in operation then as per the beam characterization defined in a static table within RF, respective number of patch/dipole elements are activated. Each mmWave module contains 4 set of 1×4 phased/dipole array of antennas or 4 set of 1×5 phased/dipole antenna, as shown in FIG. 1. When a module is active or in operation then as per the beam characterization defined in a static table within RF, respective number of patch/dipole elements are activated. Using this static table configuration, wide beam or narrow beam formation is performed by UE. But it is not adaptive and all the patch elements that required to form the required beam needs to be activated.

mmWave UEs have problems of large power consumptions due to modules or in other words, antenna array elements. In order to optimize power consumption, the existing techniques have performed optimizations in enabling and disabling a mmWave module when more than one module is supported. Effective isotropic radiated power (EIRP) is the product of transmitter power and the antenna gain in a given direction relative to an isotropic antenna of a radio transmitter. The EIRP is a directional performance parameter that can be measured for a given direction of the antenna UE. The directional EIRP is the radiated power weighted by the directional gain of the antenna. Typically, maximum EIRP can be obtained when all the elements are active. But in strong signal conditions having pre-defined number of the antenna elements (as per the static configuration defined in RF active) may not be required and will increase substantial power. Hence, reduction in power consumption is one of the biggest challenges in mmWave operation.

Hence, there is a need for techniques to address the above discussed drawbacks.

### SUMMARY

According to an example embodiment a method for adaptive antenna configuration in a user equipment comprising one or more antenna modules, each of the one or more antenna modules comprising a plurality of patch elements is provided. The method comprises: determining whether a signal strength of the user equipment (UE) is above a signal threshold, determining whether a mobility of the UE is below a mobility threshold, based on determining that the signal strength is above the signal threshold, determining at least one active antenna module among the one or more antenna modules, based on determining that the mobility of the UE is below the mobility threshold, and deactivating at least one patch element among the plurality of patch elements in the at least one antenna module.

According to an example embodiment, a user equipment (UE) for adaptive antenna configuration is provided. The UE comprises one or more antenna modules including at least one antenna, each of the antenna modules comprising a plurality of patch elements, a memory, and a processor coupled to the memory. The processor is configured to: determine whether a signal strength of the UE is above a signal threshold, determine whether a mobility of the UE is below a mobility threshold, based on determining that the signal strength is above the signal threshold, determine at least one active antenna module among the one or more antenna modules, based on determining that the mobility of the UE is below the mobility threshold, and deactivate at least one patch element among the plurality of patch elements in the at least one antenna module.

To further clarify the advantages and features of the present disclosure, a more detailed description of the disclosure will be rendered by reference to various example embodiments thereof, which are illustrated in the appended drawings. It will be appreciated that these drawings depict example embodiments of the disclosure and are therefore not to be considered limiting its scope. The disclosure will be described and explained in greater detail with reference to the accompanying drawings.

### BRIEF DESCRIPTION OF THE DRAWINGS

These and other features, aspects, and advantages of the present disclosure will be more apparent from the following detailed description, taken in conjunction with the accompanying drawings in which like characters represent like parts throughout the drawings, and in which:

FIG. 1 is a diagram illustrating an example architecture of mmWave modules, according to the existing art;

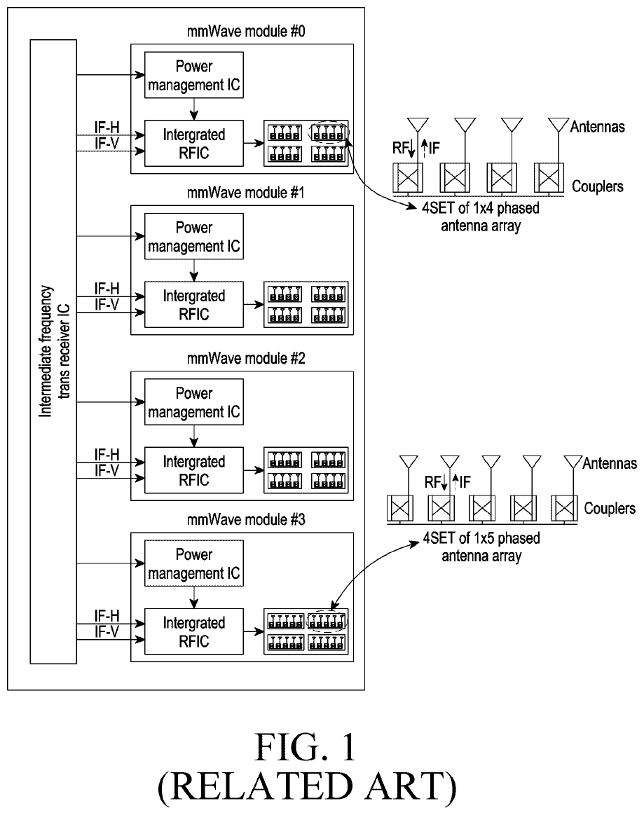

FIG. 2 is a flowchart illustrating an example method of adaptive antenna configuration in a user equipment comprising one or more antenna modules, according to various embodiments;

FIG. 3 is a block diagram illustrating an example configuration of a system for adaptive antenna configuration in a user equipment comprising one or more antenna modules, according to various embodiments; and

FIG. 4 is a diagram illustrating an example configuration of antenna modules of the UE, according to various embodiments.

Further, skilled artisans will appreciate that elements in the drawings are illustrated for simplicity and may not have been necessarily drawn to scale. For example, the flowcharts illustrate the method to help to improve understanding of aspects of the present disclosure. Furthermore, in terms of the construction of the UE, one or more components of the UE may have been represented in the drawings by conventional symbols, and the drawings may illustrate details relevant to understanding the various example embodiments of the disclosure and to not obscure the drawings with details that may be readily apparent to those of ordinary skill in the art having the benefit of the description herein.

### DETAILED DESCRIPTION

Reference will now be made to various example embodiments illustrated in the drawings. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with the embodiment being included in at least one embodiment of the present disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more UEs or sub-systems or elements or structures or components proceeded by “comprises . . . a” does not, without more constraints, preclude the existence of other UEs or other sub-systems or other elements or other structures or other components or additional UEs or additional sub-systems or additional elements or additional structures or additional components.

5G enabled user equipment (UE) use separate mmWave modules (e.g., radio frequency (RF) modules) for mmWave. In a non-limiting example, each mmWave module may contain 4 set of 1×4 phased/dipole array of antennas or 4 set of 1×5 phased/dipole antenna. Table 1 below indicates power consumed by RF antenna in the RF modules and by overall chipset during different scenarios.

TABLE 1

| | Reading PDCCH in 1 | | Downlink (DL) + Uplink (UL) | |
|---|---|---|---|---|
| | Carrier Component | | Data session | |
| Power | 4 Active | 1 Active | 4 Active | 1 Active |
| Consumption | Elements | Element | Elements | Element |
| mmWave | ~620 | ~10 | ~860 | ~20 |
| Module Power | | to ~38.75 | | to ~53.75 |
| Consumption | | | | |
| (milli Watt) | | | | |
| Overall | ~1690 | ~200 | ~2370 | ~140 |
| Chipset Power | | to ~105 | | to ~150 |
| Consumption | | | | |
| (milli Watt) | | | | |

As can be seen from Table 1, as the number of active antenna elements is increased in a mmWave module, the power consumed increases drastically. Power consumption reduces as the number of active antenna elements is reduced. Accordingly, the present disclosure discloses techniques for adaptive antenna configuration in which the patch elements will be activated or deactivated based on the data need and signal strength. For example, if the UE is in strong signal area and in low mobility with closed loop configured by the network, few patch elements are activated and remaining elements are deactivated. Patch element deactivation may make the elements in OFF state leading to reduction in power consumed by the mmWave RF module. Element deactivation may reduce antenna gain making the beam wider. Wider beams will not impact the antenna performance as UE is in strong signal area.

Various embodiments of the disclosure will be described in greater detail below with reference to the accompanying drawings.

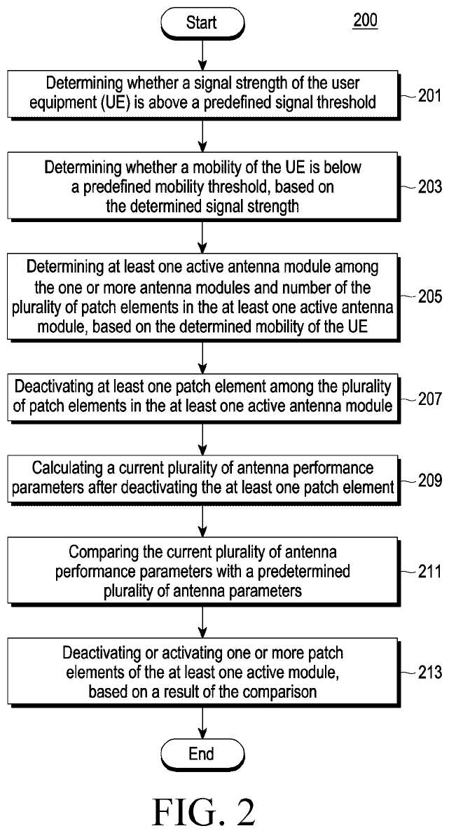

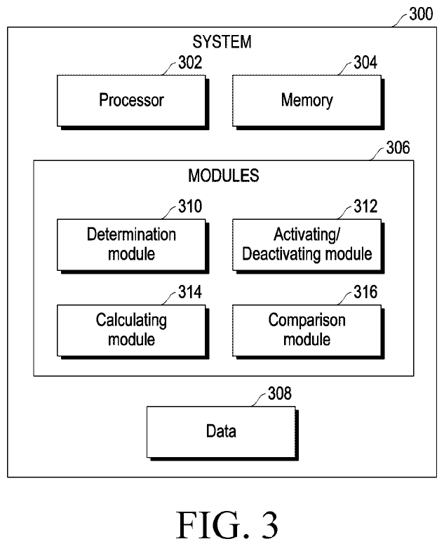

FIG. 2 is a flowchart illustrating an example method of adaptive antenna configuration in a user equipment comprising one or more antenna modules, according to various embodiments. FIG. 3 is a block diagram illustrating an example configuration of a system for adaptive antenna configuration in a user equipment comprising one or more antenna modules, according to various embodiments. For the sake of brevity, the description of FIGS. 2 and 3 are explained in conjunction with each other.

The system 300 may be implemented in a UE. The system 300 may include, but is not limited to, a processor (e.g., including processing circuitry) 302, memory 304, modules (e.g., including various processing circuitry and/or executable program instructions) 306, and data unit (e.g., including various data) 308. The modules 306 and the memory 304 may be coupled to the processor 302.

The processor 302 may include a single processing unit or several modules, all of which could include multiple computing modules. The processor 302 may be implemented, for example, and without limitation, as one or more microprocessors, microcomputers, microcontrollers, digital signal processors, central processing modules, state machines, logic circuitries, and/or any UEs that manipulate signals based on operational instructions. Among other capabilities, the processor 302 is configured to fetch and execute computer-readable instructions and data stored in the memory 304.

The memory 304 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The modules 306 amongst other things, include routines, programs, objects, components, data structures, etc., which perform particular tasks or implement data types. The modules 306 may also be implemented as, signal processor(s), state machine(s), logic circuitries, and/or any other UE or component that manipulate signals based on operational instructions.

Further, the modules 306 can be implemented in hardware, instructions executed by a processing unit, or by a combination thereof. The processing unit can comprise a computer, a processor, such as the processor 302, a state machine, a logic array, or any other suitable UEs capable of processing instructions. The processing unit can be a general-purpose processor which executes instructions to cause the general-purpose processor to perform the required tasks or, the processing unit can be dedicated to performing the required functions. In an embodiment of the present disclosure, the modules 306 may be machine-readable instructions (software) which, when executed by a processor/processing unit, perform any of the described functionalities.

In an embodiment, the modules 306 may include a determination module 310, q activating/deactivating module 312, a calculation module 314, and a comparison module 316 (which may be referred to herein as 310-316).

The various modules 310-316 may be in communication with each other. In an embodiment, the various modules 310-316 may be a part of the processor 302. In an embodiment, the processor 302 may be configured to perform the functions of modules 310-316. The data unit 308 serves, amongst other things, as a repository for storing data processed, received, and generated by one or more of the modules 306.

It should be noted that the system 300 may be a part of a UE. In an embodiment, the system 300 may be connected to the UE. It should be noted that the term “UE” refers to any electronic UEs used by a user such as a mobile UE, a desktop, a laptop, personal digital assistant (PDA) or similar UEs.

It should be noted that the term “network entity” refers to any wireless communication network entity such as a base station, gNodeB (gNB) or similar entities.

Referring to FIG. 2, as shown in FIG. 2, at 201, the method 200 may comprise determining whether a signal strength of the user equipment (UE) is above a predefined (e.g., specified) signal threshold. In an embodiment, the predefined signal threshold may be configured by the UE. For example, the predefined signal threshold may be −60 dBm. Hence, in an example embodiment, the determination module 310 may determine if the signal strength of the UE is above −60 dBm.

If the signal strength of the UE is above the predefined threshold, then, at 203, the method 200 may comprise determining whether a mobility of the UE is below a predefined mobility threshold, based on the determined signal strength. In an embodiment, predefined mobility threshold may be configured by the UE In an embodiment, the predefined mobility threshold can be defined in terms of the rate of change of signal strength. If the rate of change of signal strength is below 5%, UE is not in mobility. In an embodiment, the determination unit 310 may determine that if angle of arrival is constantly changing, then the UE is in mobility. In an embodiment, the determination unit 310 may determine that if a serving cell of the UE is changing, then the UE is in mobility. In an embodiment, the determination unit 310 may determine that if the location of the UE is changing, then the UE is in mobility. It should be noted that the determination module 310 may determine if the UE is in mobility based on any other parameters/techniques known to a person skilled in the art.

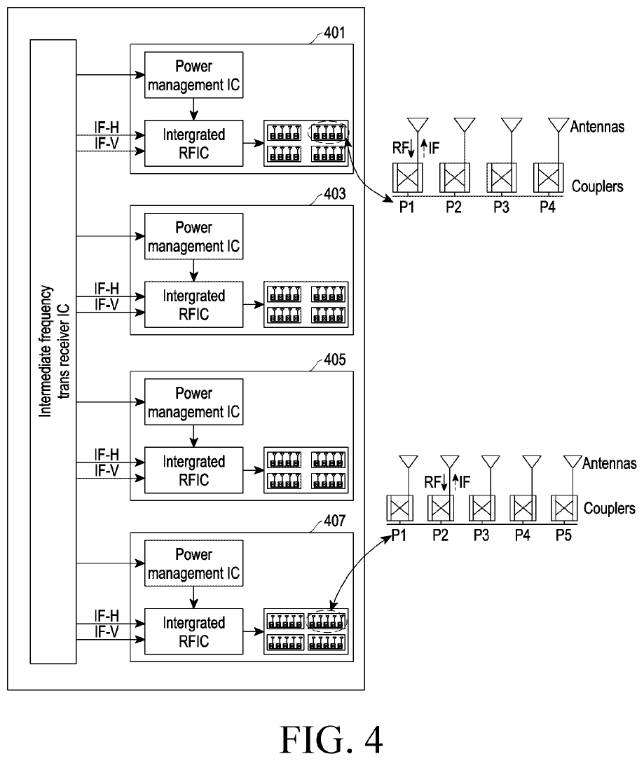

At 205, the method 200 may comprise determining at least one active antenna module among the one or more antenna modules and number of the plurality of patch elements in the at least one active antenna module, based on the determined mobility of the UE. FIG. 4 is a diagram illustrating an example configuration of antenna modules of the UE, according to various embodiments. As shown in FIG. 4, the UE may comprise of one or more antenna modules 401, 403, 405, 407 (401 . . . 407). Each antenna module may comprise of plurality of patch elements/phased array elements P1, P2, P3, P4, P5 (P1 . . . P5). For example, if it is determined that the UE is in mobility, then the determination module 310 may determine if at least one antenna module among the one or more antenna modules (401 . . . 407) is active. For example, the determination module 310 may determine that the antenna module 401 is active. It should be noted that the determination module 310 may determine which antenna module is active using the existing techniques known to a person skilled in the art. The determination module 310 may determine number of the plurality of patch elements in the at least one active antenna module. For example, the determination module 310 may determine that there are 4 patch elements in the active antenna module 401.

Referring back to FIG. 2, at 207, the method 200 may comprise deactivating at least one patch element among the plurality of patch elements in the at least one active antenna module. For example, the activating/deactivating module 312 may deactivate at least one patch element, such as P1, among the plurality of patch elements (P1 . . . P4) in the at least one active antenna module 401. It should be noted that the activating/deactivating module 312 may also deactivate more than one patch element such as P1, P2 or P1, P2, P3 or P3, P4 or any such combination of patch elements.

At 209, the method 200 may comprise calculating a current plurality of antenna performance parameters after deactivating the at least one patch element. For example, the calculation module 314 may calculate current antenna performance parameters after deactivating the patch element P1 in the active antenna module 401. In other words, the calculation module 314 may calculate current antenna performance parameters using the active patch elements P2 . . . P4. In an embodiment, the plurality of antenna performance parameters may include an effective isotropic radiated power (EIRP) transmission power, a block error rate (BLER) and antenna gain of the at least one active antenna module. It should be noted that the calculation module 314 may calculate current antenna performance parameters, using the existing techniques known to a person skilled in the art.

Referring back to FIG. 2, at 211, the method 200 may comprise comparing the plurality of current antenna performance parameters with a predetermined plurality of antenna parameters. In an embodiment, the calculation module 314 may calculate the plurality of antenna performance parameters before deactivation of the patch element P1, e.g., with all the patch elements in the active antenna module 401. Such antenna performance parameters may be referred as predetermined plurality of antenna performance parameters. Thereafter, the comparison module 316 may compare the predetermined plurality of antenna performance parameters with the current plurality of antenna performance parameters. For example, the comparison module 316 may compare the current BLER with the predetermined BLER. Similarly, the comparison module 316 may compare the current EIRP with the predetermined EIRP. In the same fashion, the comparison module 316 may compare all the current antenna performance parameters with the predetermined antenna performance parameters.

Referring back to FIG. 2, at 213, the method 200 may comprise deactivating or activating one or more patch elements of the at least one active module, based on a result of the comparison. For example, if the comparison module 316 determines that the plurality of current antenna performance parameters is greater than the plurality of predetermined is antenna parameters, then the activating/deactivating module 312 may deactivate more patch elements. For example, if one patch element P1 has been deactivated and the current antenna performance parameters determined with deactivating the patch element P1 is greater than the predetermined antenna performance parameters, then the activating/deactivating module 312 may further deactivate one or more patch elements to operate on reduced antenna array. Then, operations 209-213 will be repeated till the current antenna performance parameters determined with deactivating the patch element(s) is greater than the predetermined antenna performance parameters. In other words, this loop continues until the minimum operability for patch elements are required. In an embodiment, the activating/deactivating module 312 may also determine a number of the patch elements to be deactivated such that the current antenna performance parameters determined with deactivating the number of patch element(s) is greater than the predetermined antenna performance parameters. In an embodiment, number of patch elements to be deactivated may be stored in a memory 304 along with its associated parameters, wherein the associated parameters include configuration id, application type, associated cell information, Reference Signal Received Power (RSRP), signal-to-interference-plus-noise ratio (SINR). Table 2 below shows an example of storing such data in the memory 304:

TABLE 2

| | | #Required | | | | Valid |
|---|---|---|---|---|---|---|
| Patch | | minimum | #Signal | #Signal | | flag |
| element | Application | active patch | condition | condition | Cell | (true/ |
| id | type | elements | (RSRP) | (SINR) | info | false) |
| Config. | Strong | N_general_elements | SSB_RSRP/ | SSB_SINR/ | Cell ID, | true |
| id 1 | Signal | | CSRIRS_RSRP | CSRIRS_SINR | Band | |
| Config. | Page decode | N_page_elements | SSB_RSRP/ | SSB_SINR/ | Cell ID, | True |
| id 2 | | | CSRIRS_RSRP | CSRIRS_SINR | Band | |
| Config. | Low UL/DL | N_uldl_elements | SSB_RSRP/ | SSB_SINR/ | Cell ID, | True |
| id 3 | | | CSRIRS_RSRP | CSRIRS_SINR | Band | |
| Config. | Signalling | N_sig_elements | SSB_RSRP/ | SSB_SINR/ | Cell ID, | True |
| id 4 | | | CSRIRS_RSRP | CSRIRS_SINR | Band | |

UE may refer to this table in the memory 304 to activate the patch elements within the antenna module initially. If the criteria of the table are not met, then the UE may activate all the patch elements. Using the method as described in reference to FIG. 2, UE may learn the antenna configuration used for different application types used when camped to cells in a network and save it in the memory 304. UE may update this table in the memory 304, if there are any changes in minimum required elements for an application type.

On the other hand, if the current antenna performance parameters determined with deactivating the patch element P1 is less than the predetermined antenna performance parameters, then the activating/deactivating module 312 may activate the patch element P1. In an embodiment, if the current antenna performance parameters determined with deactivating the patch elements P1 and P2 is less than the predetermined antenna performance parameters, then the activating/deactivating module 312 may activate one of the patch elements P1 and P2. Operations 209-213 will be repeated until the current antenna performance parameters determined with deactivating the patch element(s) is greater than the predetermined antenna performance parameters.

This way, power consumption reduces as the number of active antenna elements is reduced, as shown in below table 3:

TABLE 3

Power Consumption Values by RF module (mWatt)

| Use Case | Reading PDCCH | DL + UL Data session |
|---|---|---|
| 4 Patch | ~620 | ~860 |
| Elements | | |
| 1 Patch | ~10 | ~20 |
| Elements | to ~38.75 | to ~53.75 |

Hence, when antenna elements are reduced then there is significant power consumption reduction. So, with the disclosed techniques, dynamic activation of antenna elements will reduce the power consumption without impacting the performance of the UE.

In an embodiment, the disclosed techniques may be implemented in decoding paging messages/information. In an example embodiment, paging messages may be quadrature phase shift keying (QPSK) modulated to make it robust. When UE is not in mobility and is under strong signal condition, then in that case not all antenna elements are required to be activated within a module to read the page message. In an embodiment, if UE is in strong signal condition, UE will enable the minimum required antenna elements within the active module to read the page message. Accordingly, the receiving a paging information to be decoded. Then, the paging information may be decoded with the number of deactivated patch elements, in accordance with the method as described in reference to FIG. 2. In an embodiment, the UE may refer to Table 2 in the memory 304 to retrieve the patch elements (N_page_elements) required to decode the page message. Since only few patch elements will be active, less power will be consumed. Below Table 4 shows power consumption in decoding paging information with all the patch elements being active whereas Table 5 shows consumption in decoding paging information with some of the patch elements being deactivated:

TABLE 4

| | |
|---|---|
| #active antenna module (UE | M1 (active |
| supports 3 antenna modules) | antenna module) |
| #patch elements | 4 patch elements |
| #scenario | paging decode |
| power consumption with all | ~620 mW |
| active patch elements | |

TABLE 5

| | |
|---|---|
| #active antenna module (UE | M1 (active |
| supports 3 antenna modules) | antenna module) |
| #patch elements | 1 patch elements |
| #scenario | paging decode |
| power consumption with reduced | ~38 mW |
| patch elements | |

As can be seen from Tables 4 and 5, there is a significant reduction in power consumption if the paging information is decoded with reduced number of patch elements.

In an embodiment, the disclosed techniques may be implemented in low downlink (DL)/uplink (UL) activity. In an example embodiment, when UE is in low data activity and is under strong signal condition, then in this case as well UE will use the disclosed techniques to reduce the antenna elements to save power. Typically, low UL and DL data activity may be use case for frequent chat/messaging applications. In an embodiment, the UE checks the current signal condition and determines whether it is in strong signal or not. UE then checks the mobility status using theta, phi and angle of arrival. Once UE determines that it is in low mobility, UE may check the theoretical throughput (considering the scheduling rate, resource allocation and buffer status report) in previous transmission time interval (TTI). The UE may then compare it with the actual throughput achieved in previous TTI. If the actual throughput is less than the theoretical throughput by a certain percentage (TP), then UE will determine it to be a low UL/DL session, e.g., the UL/DL activity of the UE is below a predefined threshold. The percentage difference between actual and achieved throughput may be configured in UE per session. The configuration may be provided by the upper layers (application layer) or may be configured in modem to a predefined threshold value. The UE can also use machine learning (ML) techniques to determine low/high data rate. Based on modulation and coding scheme (MCS) allocation, UE determines the robustness of data. QPSK being highly robust compared to 256QAM. Then the UE determines whether a block error rate (BLER) is within a predefined range. The predefined range may be configurable and may be configured within UE in the range defined by 3GPP standard. For example, the predefined range may be 10%. If yes, then UE the may perform the following operations:
1) deactivating the one or more patch elements of the at least one antenna module;
2) monitoring change in the BLER after deactivation of the one or more patch elements;
3) determining whether the change in the BLER is above a predefined down threshold. The predefined down threshold may be configurable and may be configured by the UE.
4) performing the UL/DL activity with the deactivated one or more patch elements, based on the determination that the change in the BLER is above the predefined down threshold.

UE will repeat this process in the next measurement cycle to check whether further reduction can be performed or not. If not, then UE will activate the deactivated elements. If yes, then UE will further deactivate the elements.

Hence, using the disclosed techniques, the UE shall be able to decode UL and DL data from network using minimal and/or reduced set of patch elements. Hence, it saves the power in this use case where user application has low uplink and downlink data activity. As a further optimization, by knowing the number of patch elements used in this use case, UE could further use ML techniques, and dynamically predict the minimum number of patch elements to be activated for low UL/DL cases.

Below Table 6 shows power consumption in decoding decode UL and DL data with all the patch elements being active whereas Table 7 shows consumption in decoding decode UL and DL data with some of the patch elements being deactivated:

TABLE 6

| | |
|---|---|
| #active antenna module (UE | M1 (active |
| supports 3 antenna modules) | antenna module) |
| #patch elements | 4 patch elements |
| #scenario | Low UL/DL data session |
| Patch element reduction required | Yes, 6 dBm |
| power consumption with all | ~860 mW |
| active patch elements | |

TABLE 7

| | |
|---|---|
| #active antenna module (UE | M1 (active |
| supports 3 antenna modules) | antenna module) |
| #patch elements | 1 patch elements |
| #scenario | Low UL/DL data session |
| Patch element reduction required | Yes |
| power consumption with reduced | ~50 mW |
| patch elements | |

As can be seen from Tables 6 and 7, there is a significant reduction in power consumption if the UL/DL data is decoded with reduced number of patch elements.

In an embodiment, the disclosed techniques may be implemented in transmission/reception of signalling information (SI). In an embodiment, when UE is in strong signal condition and needs to exchange signalling information with network, then in this case as well UE may use the method as described in reference to FIG. 2, to reduce the elements to save power. It is determined if the UE has to transmit/receive signalling information with network (such as TAU, service Request, PDU session establishment/modification, etc.). The UE may determine minimum number of patch elements required using the method 200. Or the UE may determine the minimum number of patch elements from table 2 in the memory 304 (Say, N_low_sig_elements). The UE may maintain this parameter in Table 2 and use this whenever signalling information needs to be exchanged with network. The UE may transmit or receive the signalling information (SI) with the number of deactivated patch elements. UE may increase the active elements if criteria are not satisfied. Hence, using the disclosed techniques, the UE shall be able to exchange signalling messages with network using minimal and/or reduced set of patch elements. Hence it saves the power in this use case where UE needs to exchange just signalling information with network.

It should be noted that the disclosed techniques may be performed using a machine learning based method for mmWave config so that the UE can learn based on its history for initial antenna elements to be configured.

Thus, the present disclosure provides significant power saving as dynamically the number antenna elements are adjusted in various use case scenarios.

While specific language has been used to describe the disclosure, any limitations arising on account of the same are not intended. As would be apparent to a person in the art, various working modifications may be made to the method in order to implement the disclosure as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flowchart need not be implemented in the order shown; nor do all of the acts necessarily need to be performed. Also, those acts that are not dependent on other acts may be performed in parallel with the other acts. The scope of embodiments is not limited by these specific examples. Numerous variations, whether explicitly given in the disclosure or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While the disclosure has been illustrated and described with reference to various example embodiments, it will be understood that the various example embodiments are intended to be illustrative, not limiting. It will also be understood by those skilled in the art that various changes in form and detail may be made without departing from the true spirit and full scope of the disclosure, including the appended claims and their equivalents. It will also be understood than any of the embodiment(s) described herein may be used in conjunction with any other embodiment(s) described herein.

What is claimed is:

1. A method for adaptive antenna configuration in a user equipment comprising one or more antenna modules, each of the one or more antenna modules comprising a plurality of patch elements, the method comprising:
determining whether a signal strength of the user equipment (UE) is above a signal threshold;
determining whether a mobility of the UE is below a mobility threshold, based on determining that the signal strength is above the signal threshold;
determining at least one active antenna module among the one or more antenna modules, based on determining that the mobility of the UE is below the mobility threshold; and
deactivating at least one patch element among the plurality of patch elements in the at least one active antenna module.

2. The method of claim 1, further comprising:
determining a number of the patch elements to be deactivated, wherein the plurality of current antenna performance parameters is better than the plurality of predetermined antenna parameters, with deactivation of the number of the patch elements.

3. The method of claim 2, further comprising:
storing the number of patch elements to be deactivated in a memory together with its associated parameters, wherein the associated parameters include at least one of configuration id, application type, associated cell information, Reference Signal Received Power (RSRP), and signal-to-interference-plus-noise ratio (SINR).

4. The method of claim 1, wherein the plurality of antenna performance parameters includes at least one of an effective isotropic radiated power (EIRP) transmission power, a block error rate (BLER) and antenna gain of the at least one active antenna module.

5. The method of claim 1, further comprising:
calculating a current plurality of antenna performance parameters after deactivating the at least one patch element;
comparing the current plurality of antenna performance parameters with a predetermined plurality of antenna parameters; and
deactivating or activating one or more patch elements of the at least one active module, based on a result of the comparison

6. The method of claim 5, wherein the predetermined plurality of antenna parameters is determined before deactivation of the at least one patch element.

7. The method of claim 1, further comprising:
receiving a paging information to be decoded; and
decoding the paging information with the number of deactivated patch elements.

8. The method of claim 1, further comprising:
determining whether the UE is to transmit or receive signalling information (SI); and
transmitting or receiving the signalling information (SI) with the number of deactivated patch elements.

9. The method of claim 1, further comprising:
determining whether an uplink/downlink (UL/DL) activity of the UE is below a threshold;
determining whether a block error rate (BLER) is within a specified range based on determining that the UL/DL activity of the UE is below the threshold;
deactivating the one or more patch elements of the at least one antenna module based on determining that the BLER is within the specified range;
monitoring change in the BLER after deactivation of the one or more patch elements;
determining whether the change in the BLER is above a down threshold; and
performing the UL/DL activity with the deactivated one or more patch elements, based on determining that the change in the BLER is above the down threshold.

10. The method of claim 1, wherein the plurality of patch elements corresponds to a plurality of phased array elements.

11. A user equipment (UE) for adaptive antenna configuration, the UE comprising:
one or more antenna modules, each of the one or more antenna modules comprising a plurality of patch elements;
a memory; and
a processor coupled to the memory and configured to:
determine whether a signal strength of the UE is above a signal threshold,
determine whether a mobility of the UE is a specified mobility threshold, based on determining that the signal strength is above the signal threshold,
determine at least one active antenna module among the one or more antenna modules, based on determining that the mobility of the UE is below the mobility threshold, and
deactivate at least one patch element among the plurality of patch elements in the at least one active antenna module.

12. The UE of claim 11, wherein the processor further configured to:
determine a number of the patch elements to be deactivated, wherein the plurality of current antenna performance parameters is better than the plurality of predetermined antenna parameters, with deactivation of the number of the patch elements.

13. The UE of claim 12, wherein the processor further configured to:
store the number of patch elements to be deactivated in a memory together with its associated parameters, wherein the associated parameters include at least one of configuration id, application type, associated cell information, Reference Signal Received Power (RSRP), and signal-to-interference-plus-noise ratio (SINR).

14. The UE of claim 11, wherein the plurality of antenna performance parameters includes at least one of an effective isotropic radiated power (EIRP) transmission power, a block error rate (BLER) and antenna gain of the at least one active antenna module.

15. The UE of claim 11, wherein the processor further configured to:
calculate a current plurality of antenna performance parameters after deactivating the at least one patch element;
compare the current plurality of antenna performance parameters with a predetermined plurality of antenna parameters; and
deactivate or activate one or more patch elements of the at least one active module, based on a result of the comparison

16. The UE of claim 15, wherein the predetermined plurality of antenna parameters is determined before deactivation of the at least one patch element.

17. The UE of claim 11, wherein the processor further configured to:
receive a paging information to be decoded; and
decode the paging information with the number of deactivated patch elements.

18. The UE of claim 11, wherein the processor further configured to:
determine whether the UE is to transmit or receive signalling information (SI); and
transmit or receive the signalling information (SI) with the number of deactivated patch elements.

19. The UE of claim 11, wherein the processor further configured to:
determine whether an uplink/downlink (UL/DL) activity of the UE is below a threshold;
determine whether a block error rate (BLER) is within a specified range based on determining that the UL/DL activity of the UE is below the threshold;
deactivate the one or more patch elements of the at least one antenna module based on determining that the BLER is within the specified range;
monitor change in the BLER after deactivation of the one or more patch elements;
determine whether the change in the BLER is above a down threshold; and
perform the UL/DL activity with the deactivated one or more patch elements, based on determining that the change in the BLER is above the down threshold.

20. The UE of claim 11, wherein the plurality of patch elements corresponds to a plurality of phased array elements.
